(19) United States
(12) Patent Application Publication
(10) Pub. No.: US 2013/0265410 A1
(43) Pub. Date: Oct. 10, 2013

(54) COLOR VISION INSPECTION SYSTEM AND METHOD OF INSPECTING A VEHICLE

(71) Applicant: MAHLE POWERTRAIN, LLC, Farmington Hills, MI (US)

(72) Inventor: Louis Scott Bolt, New Hudson, MI (US)

(21) Appl. No.: 13/859,110

(22) Filed: Apr. 9, 2013

Related U.S. Application Data
(60) Provisional application No. 61/622,222, filed on Apr. 10, 2012.

(51) Int. Cl. G06T 7/00

(52) U.S. Cl. CPC G06T 7/0004
USPC 348/86

(57) ABSTRACT

A color vision inspection system to inspect quality of a vehicle includes at least one camera to capture an inspection image of an inspection target and at least one inspection item on a vehicle. The color vision inspection system also includes a computer communicating with the at least one camera to analyze the inspection image with a calibration image and with CPK statistical analysis determine a percentage difference in a match of the inspection image to the calibration image to conclude whether the inspection item passed the inspection.

### CROSS-REFERENCE TO RELATED APPLICATION(S)

The present application claims the priority date of co-pending U.S. Provisional Patent Application Ser. No. 61/622,222, filed Apr. 10, 2012.

### BACKGROUND OF THE INVENTION

1. Field of the Invention

The present invention is directed toward a color vision inspection system for an automotive vehicle as well as a method of inspecting the automotive vehicle.

2. Description of the Related Art

Current vision inspection systems employed to inspect automotive vehicles typically use a multitude of cameras to take photographs of various items of the vehicle undergoing inspection. For example, one camera is used for one brake light. Each camera takes a photograph for each inspection item that is sent to a computer for comparison with a photograph of that inspection item stored in the computer. The computer performs the comparison to determine whether that item of the vehicle passes inspection.

Several disadvantages exist with current vision inspection systems. For example, these vision inspection systems require several cameras, computers, cabling, etc. and also the end user to setup and maintain the system. Yet another disadvantage of these vision inspection systems is that they require a controlled area and lighting conditions to work properly and also require exact positioning of the part under inspection to work properly. A further disadvantage of these vision inspection systems is that they are primarily designed to handle a single part of a single line for the most part and handle part variation poorly. Still another disadvantage is that these vision inspection systems do not have the ability to have multiple scenes per camera such that there is no single image to perform a number of inspections. Further, each camera is relatively expensive and the calibration for each camera is also relatively expensive.

Accordingly, there remains a need in the art for a vision inspection system designed to quickly and cost-effectively test and inspect an automotive vehicle. Furthermore, there remains a need in the art for such a system that can be used in a general lighting environment common to an automotive vehicle production plant. In addition, there remains a need in the art for such a system that can be operated for vehicle parts, which may not be in the same testing position every time. There also remains a need in the art for such a system that has the ability to have multiple scenes per camera, allowing the operator to put the vehicle/part in different states to be analyzed. Finally, there remains a need in the art for a color vision inspection system that uses a minimal amount of low cost hardware and statistical analysis to inspect an automotive vehicle to determine if an inspected part has passed inspection.

### SUMMARY OF THE INVENTION

The present invention overcomes the deficiencies in the related art in a color vision inspection system to inspect quality of an automotive vehicle. The color vision inspection system includes a computer and at least one camera disposed around an automotive vehicle and communicating with the computer. The camera captures an inspection image of one or more inspection items on the automotive vehicle including a test target that is sent to the computer for analysis. The captured image is analyzed by the computer with a setting created in a calibration interface (limits, color selection mask, sensitivity of the mask, position of the item to inspect, etc.). The computer uses a CPK statistical analysis and the percentage difference in the match of the inspection image to the calibration image is computed using an algorithm. Based on the percentage difference, the computer concludes whether the inspection item passed the inspection.

In addition, the present invention is a method of inspecting an automotive vehicle having at least one inspection item using a color vision inspection system. The method includes the steps of selecting by a computer of the color vision inspection system a good image of an inspection item on the automotive vehicle and selecting by the computer a blurred image of the inspection item on the automotive vehicle. The method also includes the steps of making by the computer a calibration mask of the good inspection item based on the good image and blurred image of the inspection item. The method includes the steps of taking by a camera of the color vision inspection system a good image of a portion of the automotive vehicle having at least one inspection item, determining by the computer the inspection item search area from the camera, and making by the computer an inspection mask of the inspection item search area based on the images of the inspection item search area. The method further includes the steps of determining by the computer a percentage difference between a best match of the calibration mask of the good inspection item and the inspection mask of the inspection item search area. The method still further includes the steps of concluding by the computer whether the inspection item passed the inspection based on the percentage difference between what is deemed a good or passed vehicle, and what is deemed a defective or failed vehicle with a defect for the inspected vehicle.

One advantage of the present invention is that the color vision inspection system can be implemented using a minimal amount of low cost hardware such as cameras, computers, cabling, etc. Another advantage of the present invention is that the color vision inspection system can be setup and maintained by the end user and it can be utilized in a general lighting environment common to an automotive vehicle production plant. Still another advantage of the present invention is that the color vision inspection system can be used for vehicle parts, which may not be in the same testing position every time and it can use rules to handle variants of vehicle parts being tested. A further advantage of the present invention is that the color vision inspection system has the ability to have multiple scenes per camera, allowing the operator to put the vehicle/part in different states to be analyzed. A still further advantage of the present invention is that the color vision inspection system is more accurate, less expensive, and easier to setup and maintain than current vision inspection systems.

### BRIEF DESCRIPTION OF THE DRAWINGS

Other advantages of the present invention will be readily appreciated as the same becomes better understood by reference to the following detailed description when considered in connection with the accompanying drawings, wherein:

FIG. 1 is a schematic view illustrating a color vision inspection system, according to the present invention, in operational relationship with an automotive vehicle;

FIG. 2 is a computer screen view of an image of the automotive vehicle captured with the color vision inspection system of FIG. 1 illustrating a calibration inspection condition;

FIG. 3 is a graph illustrating a differentiation comparison;

FIG. 4 is a flowchart illustrating the steps of a method, according to the present invention, for inspecting a vehicle with a color vision inspection program of the present invention;

FIG. 5 is a computer screen view of an image of a portion of the automotive vehicle captured with the color vision inspection system of FIG. 1 illustrating a failed inspection condition; and

FIG. 6 is a computer screen view of an image of a portion of the automotive vehicle captured with the color vision inspection system of FIG. 1 illustrating a passed inspection condition.

### DETAILED DESCRIPTION OF THE INVENTION

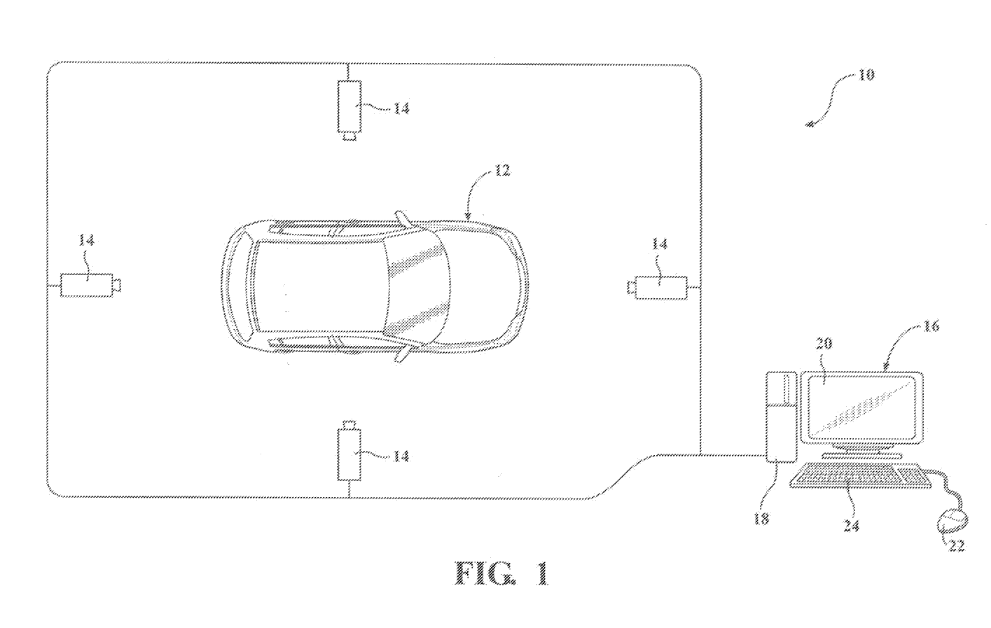

Referring now to the figures, a color vision inspection system, according to the present invention, is generally indicated at 10 in the schematic drawing of FIG. 1. In the representative example illustrated herein, the system 10 is used to inspect quality of an automotive vehicle, generally indicated at 12. However, those having ordinary skill in the art will appreciate from the description that follows that the system 10 may be employed to inspect the quality of any number of devices and things. In any event, and as described in greater detail below, in this representative example, the color vision inspection system 10 performs a quality control check of the automotive vehicle 12. The system 10 includes at least one, preferably a plurality of cameras 14, disposed about the automotive vehicle 12. In the embodiment illustrated, one camera 12 is disposed on each side of the automotive vehicle 12. The cameras 14 are used to capture a digital color image of a portion of the automotive vehicle 12. It should be appreciated that the cameras 14 are conventional.

The color vision inspection system 10 also includes a control system, generally indicated at 16, to operatively control the cameras 14 and to activate inspection items on the automotive vehicle 12. The control system 16 includes a computer 18 having a memory (not shown) and a processor (not shown), a display 20, and user input mechanism, such as a mouse 22 or keyboard 24. The control system 16 communicates with the cameras 14 and the automotive vehicle 12 with cabling connected between the automotive vehicle 12, cameras 14, and computer 18. In another embodiment, the automotive vehicle 12, cameras 14, and control system 16 communicate with each other wirelessly. The control system 16 further includes a computer program that is employed to perform a method for inspecting the automotive vehicle 12 that is resident on the computer 18 and controls the cameras 14 and activation of inspection items, e.g. brake lights, on the automotive vehicle 12.

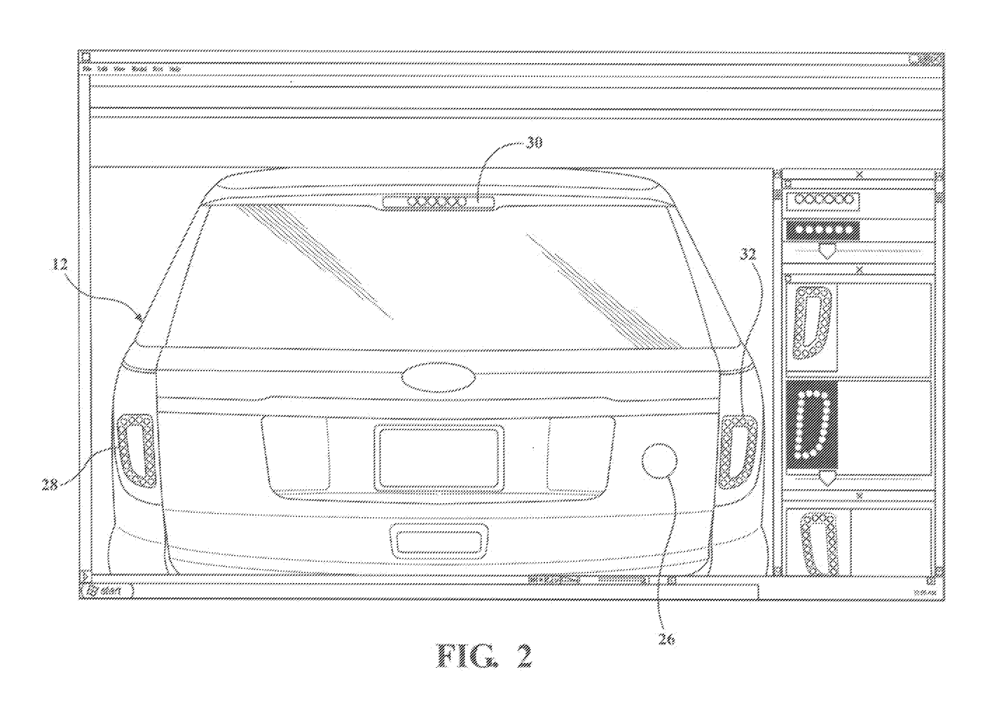

The color vision inspection system 10 of the present invention may be employed during the automotive inspection process. Thus, the color vision inspection system 10 is particularly adapted for performing color vision quality inspection of the automotive vehicle 12. In its operative mode, the color vision inspection system 10 uses vision technology and color imaging which utilizes filtering and image match techniques combined with statistical analysis to inspect the automotive vehicle 12. The inspection process is a hard coded computer program in the computer 18 far each inspection item such as a vehicle part to be inspected. The method includes making a camera setup tab to mate inspection process with a particular camera 14 using, for example, a camera name or number. The method allows vehicle diagnostic commands to activate various lights and actuators that are then captured by the various cameras 14. For example, the computer 18 sends a command to illuminate a brake light on the automotive vehicle 12 through a computer link from the computer 18 to automotive vehicle 12. The camera 14 captures a single image of one or more inspection items, e.g., brake lights, on the automotive vehicle 12 including an inspection target 26 (FIG. 2) that is sent to the computer 18 for analysis. The captured image is analyzed by the computer 18 with a setting created in a calibration interlace (limits, color selection mask, sensitivity of the mask, position of the item to inspect etc.). Each inspection item can have a different calibration limit. The computer 18 uses standard CPK statistical analysis methods and the percentage difference in the match of the inspection image to the calibration image is computed using an algorithm. Based on the percentage difference, the computer 18 concludes whether the inspection item passed the inspection.

Referring to FIG. 2, a computer screen view is shown of an image for calibration of a portion of the automotive vehicle 12 captured with the color vision inspection system 10. In the computer screen view, the image shown was captured with the rear camera 14 and shows an inspection target 26 and all three (3) rear brake lights 28,30,32 of the automotive vehicle 12 being illuminated to create a calibration interface for that portion of the automotive vehicle 12 with the color vision inspection system 10. The calibration interface includes programmed limits (e.g. whether the brake lights 28,30,32 are illuminated), color selection mask (e.g., brake lights 28,30,32 are red), sensitivity of the mask, (e.g., ninety percent illumination of the brake lights 28/30,32), position of the item to inspect (e.g., brake lights 28,30,32 parallel to the camera 14), etc. The color vision inspection system 10 allows n inspection items such as vehicle/part types in a single calibration. The color vision inspection system 10 allows n inspection items within a single camera image. As illustrated in FIG. 2, three brake lights 28,30,32 are the three inspection items along with the inspection target 26 within a single camera Image. Each inspection item can have a different calibration limit. In the embodiment illustrated, each of the three brake lights 28,30,32 can have a different calibration limit. The color vision inspection system 10 includes the inspection target 26 in the image and the color proportion of the inspection target 26 Is determined by the computer program to create a color selection mask. It should be appreciated that the color selection mask acts as a filter to account for a difference in lighting conditions.

In operation, one or more cameras 14 are placed in an automotive bay of an automotive plant for the automotive vehicle 12 to enter. The automotive vehicle 12 enters the bay and an inspection target 26 is placed on the vehicle 12. The camera 14 captures a single image of a portion of the vehicle 12 including the inspection target 26 and inspection items on the automotive vehicle 12. The captured image is sent to the computer 18 and the captured image is analyzed with the setting created in the calibration interface. The inspection items are compared against calibration limits by the computer 18. The computer 18 performs CPK statistical analysis and determines a percentage difference in match of the inspection image to the calibration image. The computer 18 then concludes whether the inspection items pass or fail based on the percentage difference in match for the inspection.

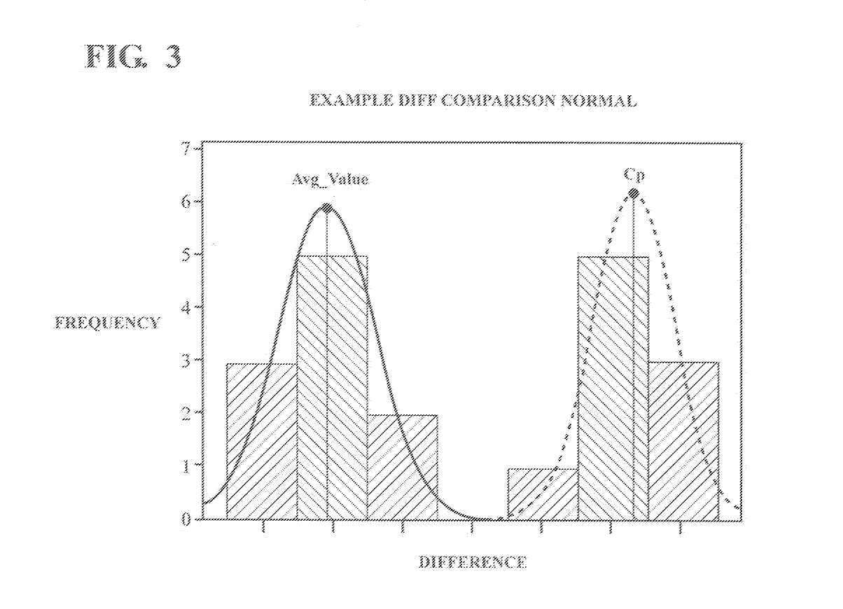

The computer 18 also includes software that is used to create histograms. The histograms are essentially compilations of relevant data derived from a series of test vehicles. This data constitutes baseline information against which the production vehicles are measured. The baseline data may be filtered by plant, carline, vehicle type, vehicle part, etc. Average values for pre-selected time slices are calculated for the sample, baseline vehicles. The standard deviation for the sample set is also calculated and stored in the histograms. A density curve is then developed for the sample vehicles. Vehicles of a predetermined size without defects represent the sample set. A critical point is then established to compare the performance of the production vehicles with the average value of the sample set. In one possible test scenario, the average value for vehicles with an inspection item, for example a “light-out” or “non-illuminated light” represents a “critical point.” Using this critical point, the difference between a “lit light” of “illuminated light” of a vehicle and a “non-illuminated light” of a vehicle can be determined. A graph illustrating a differentiation comparison is shown in FIG. 3.

The area under the density curve for an “illuminated light” vehicle between 100% and the critical point can be calculated using conventional statistical calculations. Using these calculations, the accuracy for detecting only the “illuminated light” vehicles for a given time is determined by measuring the area under the density curve for the sample mean to the critical point, and then adding a predetermined value to account for all values in the curve that are less than the sample mean. The calculation of the average under the density curve is made using a “Z table.” Using these calculations, the color vision inspection system 10 of the present invention is able to quickly, effectively, and accurately determine whether the inspection items passed inspection of production vehicles in under 30 seconds. In addition, because of the speed with which the inspection may be employed, every vehicle in a production environment may be inspected.

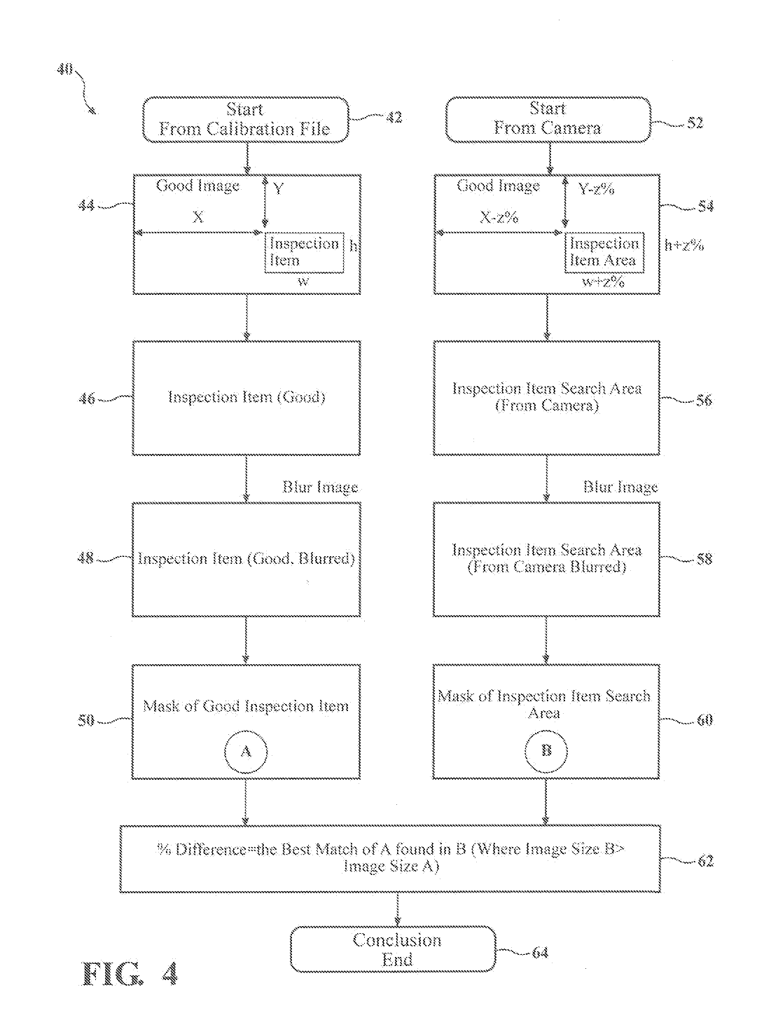

A method of inspecting an automotive vehicle 12 using the color vision inspection system 10 of the present invention may be further described with reference to the flowchart, generally indicated at 40 in FIG. 4, of a computer program resident on the computer 18. The method begins at 42 from a calibration file and proceeds to block 44 where the computer 18 selects a good image of at least one inspection item on the automotive vehicle 12. The method then advances to block 46 and the computer 18 determines that the inspection item is good based on the good image of the inspection item. The method advances to block 48 and the computer 18 selects a blurred image of the inspection item on the automotive vehicle 12. The computer 18 determines that the inspection item is blurred based on the blurred image of the inspection item. The method then advances to block 50 and the computer 18 makes a calibration mask of the good inspection item based on the good image and blurred image of the inspection item.

The method then begins again at 52 from the camera 14 and proceeds to block 54 where the camera 14 takes a good image of a portion of the automotive vehicle 12 having at least one inspection item. The method advances to block 56 and the computer 18 determines the inspection item search area from the camera 14. The method advances to block 58 and the computer 18 determines the inspection item search area from the camera is blurred based on an image from the camera 14. The method advances to block 60 and the computer 18 makes an inspection mask of the inspection item search area based on the images of the inspection item search area.

After block 60, the method advances to block 62 and the computer 18 determines the percentage difference between the best match of the calibration mask of the good inspection item and the inspection mask of the inspection item search area. The image size of the mask of the inspection item search area is greater than the image size of the calibration mask of the good inspection item. The method then advances to block 64 and the computer concludes whether the inspection item passed the inspection based on limits for the inspected vehicle. The limits referred to at this step in the method include the statistical limit between what is deemed a good or passed vehicle, and what is deemed a defective or failed vehicle with a defect.

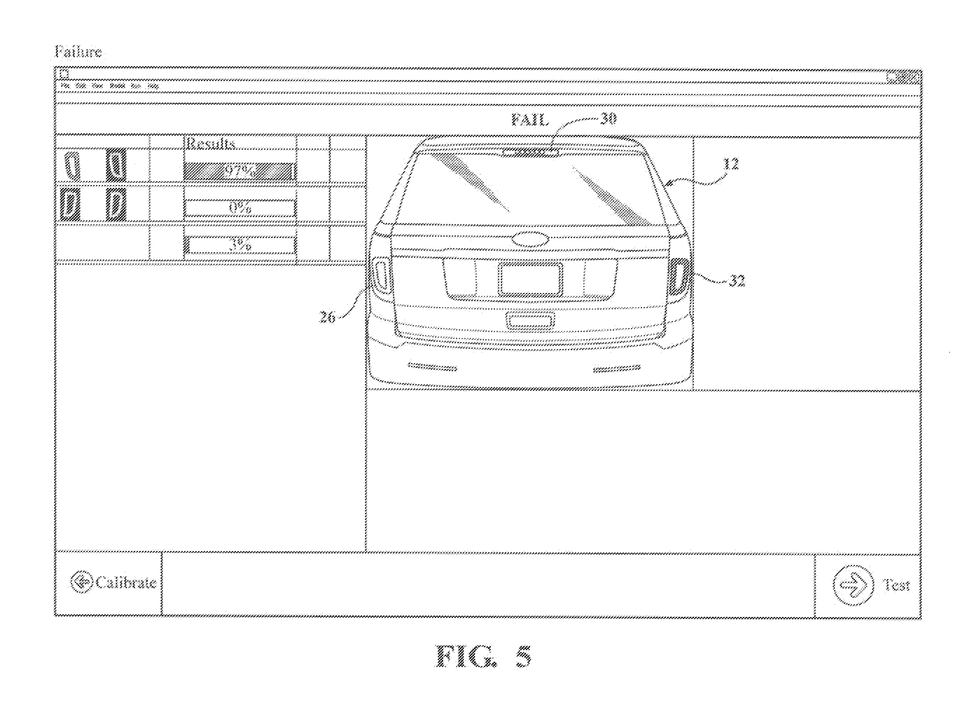

Referring to FIG. 5, a computer screen view is shown of an image during inspection for a portion of the automotive vehicle 12 captured with the color vision inspection system 10. In the computer screen view, the image shown was captured with the rear camera 14 and shows all three (3) near brake lights 28,30,32 of the automotive vehicle 12. In this view, the rear brake light 28 is not illuminated and the rear brake lights 30,32 are illuminated. The computer program in the computer 18 analyzes the captured image with the setting created in the calibration interface for each of the rear brake lights 28,30,32. The computer program compares the inspection items against calibration limits by the computer 18. The computer 18 performs CPK statistical analysis and determines a percentage difference in match of the inspection image to the calibration image. In the embodiment illustrated, the percentage difference in match for the rear brake light 28 is 97%, the rear brake light 30 is 3%, and the rear brake light 32 is 0%. Based on these percentage differences, the computer 18 concludes that the rear brake light 28 has exceeded its limit and failed inspection. The computer also concludes that the rear brake lights 30,32 are within their limits and have passed inspection.

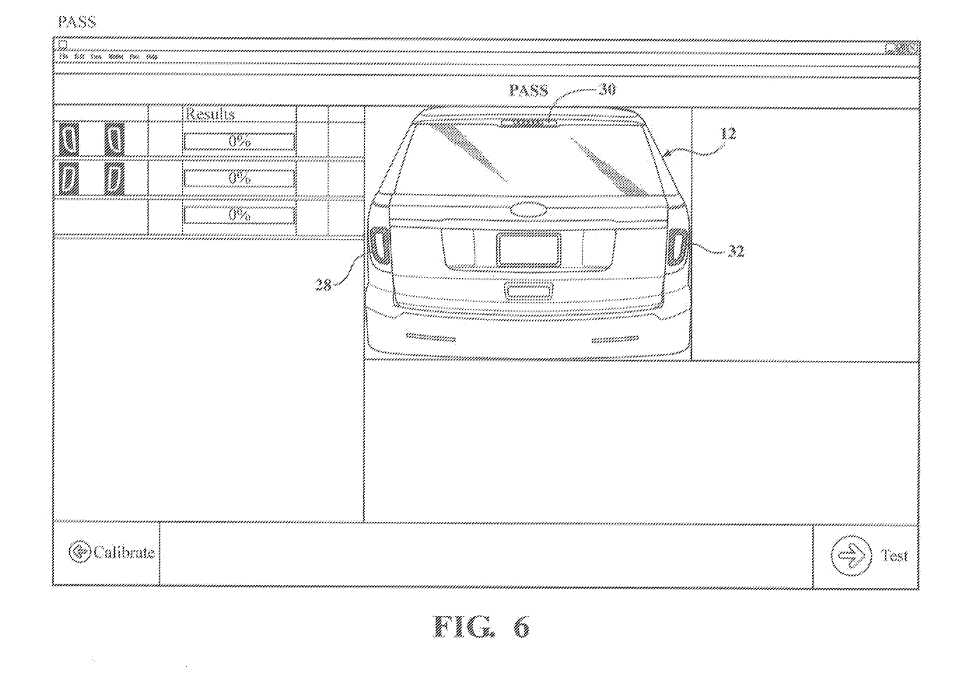

Referring to FIG. 6, a computer screen view is shown of an image during inspection for a portion of the automotive vehicle 12 captured with the color vision inspection system 10. In the computer screen view, the image shown was captured with the rear camera 14 and shows all three (3) rear brake lights 28,30,32 of the automotive vehicle 12. In this view, all three rear brake lights 28,30,32 are illuminated. The computer program in the computer 18 analyzes the captured image with the setting created in the calibration interface for each of the rear brake lights 28,30,32. The computer program compares the inspection items against calibration limits by the computer 18. The computer 18 performs CPK statistical analysis and determines a percentage difference in match of the inspection image to the calibration image. In the embodiment illustrated, the percentage difference in match for the rear brake light 28 is 0%, the rear brake light 30 is 0%, and the rear brake light 32 is 0%. Based on these percentage differences, the computer 18 concludes that all three rear brake lights 28,30,32 are within their limits and have passed inspection.

In this way, the color vision inspection system 10 of the present invention can be implemented using a minimal amount of low cost hardware such as cameras, computers, cabling, etc. The color vision inspection system 10 can be setup and maintained by the user and it can be utilized in a general lighting environment common to a vehicle production plant. Thus, the color vision inspection system 10 can be used for parts, which may not be in the same testing position every time, and it can use rules to handle variants of parts being inspected. Finally, the color vision inspection system 10 has the ability to have multiple scenes per camera, allowing the operator to put the vehicle/part in different states to be analyzed.

The present invention has been described in an illustrative manner. It is to be understood that the terminology that has been used is intended to be in the nature of words of description rather than of limitation. Many modifications and variations of the present invention are possible in light of the above teachings. Therefore, the present invention may be practiced other than as specifically described.

1. A color vision inspection system to inspect quality of an automotive vehicle comprising:
at least one camera to capture an inspection image of an inspection target and at least one inspection item on an automotive vehicle; and
a computer communicating with the at least one camera to analyze the captured inspection image with a calibration image and with CPK statistical analysis to determine a percentage difference in a match of the inspection image to the calibration image to conclude whether the inspection item passed the inspection.

2. A color vision inspection system as set forth in claim 1 wherein said at least one camera comprises a plurality of cameras disposed about the automotive vehicle.

3. A color vision inspection system as set forth in claim 2 wherein one of said cameras is disposed on each side of the automotive vehicle.

4. A color vision inspection system as set forth in claim 2 including a control system to operatively control said cameras and to activate inspection items on the automotive vehicle.

5. A color vision inspection system as set forth in claim 4 wherein said control system includes said computer, a display, and user input mechanism.

6. A color vision inspection system as set forth in claim 4 including a communication system for allowing said control system to communicate with said cameras and the automotive vehicle.

7. A color vision inspection system as set forth in claim 1 including a computer program employed to perform a method for inspecting the automotive vehicle that is resident on said computer and controls said cameras and activation of the at least one inspection items.

8. A color vision inspection system to inspect quality of an automotive vehicle comprising:
a plurality of cameras disposed about the automotive vehicle, one of said cameras is disposed on each side of the automotive vehicle to capture an inspection image of an inspection target and at least one inspection item on an automotive vehicle; and
a computer communicating with said cameras to analyze the captured inspection image with a calibration image and with CPK statistical analysis determine a percentage difference in a match of the inspection image to the calibration image to conclude whether the at least one inspection item passed the inspection.

9. A method of inspecting an automotive vehicle having at least one inspection item using a color vision inspection system, said method comprising the steps of:
selecting by a computer of the color vision inspection system a good image of an inspection item on the automotive vehicle;
selecting by the computer a blurred image of the inspection item on the automotive vehicle;
making by the computer a calibration mask of the good inspection item based on the good image and blurred image of the inspection item;
taking by a camera of the color vision inspection system a good image of a portion of the automotive vehicle having at least one inspection item;
determining by the computer the inspection item search area from the camera;
making by the computer an inspection mask of the inspection item search area based on the images of the inspection item search area;
determining by the computer a percentage difference between a best match of the calibration mask of the good inspection item and the inspection mask of the inspection item search area; and
concluding by the computer whether the inspection item passed the inspection based on the percentage difference between what is deemed a good or passed vehicle, and what is deemed a detective or failed vehicle with a defect for the inspected vehicle.

10. A method as set forth in claim 9 including the step of determining by the computer that the inspection item is good based on the good image of the inspection item.

11. A method as set forth in claim 9 including the step of determining by the computer that the inspection item is blurred based on the blurred image of the inspection item.

12. A method as set forth in claim 9 including the step of determining by the computer the inspection item search area from the camera is blurred based on an image from the camera.

13. A method as set forth in claim 9 including the step of determining by the computer whether the image size of the mask of the inspection item search area is greater than the image size of the calibration mask of the good inspection item.

14. A method as set forth in claim 9 including the step of performing CPK statistical analysis by the computer to determine percentage difference between a best match of the calibration mask of the good inspection item and the inspection mask of the inspection item search area.

15. A method of inspecting an automotive vehicle having at least one inspection item using a color vision inspection system, said method comprising the steps of:
taking by a camera of the color vision inspection system a good image of a portion of the automotive vehicle having at least one inspection item;
determining by a computer of the color vision inspection system the inspection item search area from the camera;
determining by the computer the inspection item search area from the camera is blurred based on an image from the camera;
making by the computer an inspection mask of the inspection item search area based on the images of the inspection item search area;
selecting by a computer of the color vision inspection system a good image of an inspection item on the automotive vehicle;
determining by the computer that the inspection item is good based on the good image of the inspection item;
selecting by the computer a blurred image of the inspection item on the automotive vehicle;
determining by the computer that the inspection item is blurred based on the blurred image of the inspection item;
making by the computer a calibration mask of the good inspection item based on the good image and blurred image of the inspection item; and
performing CPK statistical analysis by the computer and determining a percentage difference between a best match of the calibration mask of the good inspection item and the inspection mask of the inspection item search area; and
concluding by the computer whether the inspection item passed the inspection based on the percentage difference between what is deemed a good or passed vehicle, and what is deemed a defective or failed vehicle with a defect for the inspected vehicle.
